(19) United States
(12) Patent Application Publication
(10) Pub. No.: US 2010/0192351 A1
(43) Pub. Date: Aug. 5, 2010

(54) METHOD FOR PRODUCING AN ANNULAR WALL STRUCTURE

(75) Inventor: Henrik Runnemalm, Vanersborg (SE)

Correspondence Address: WRB-IP LLP, 801 N. Pitt Street, Suite 123, ALEXANDRIA, VA, 22314, US

(73) Assignee: VOLVO AERO CORPORATION, Trollhattan (SE)

(21) Appl. No.: 12/664,376

(22) PCT Filed: Jul. 9, 2007
(86) PCT No.: PCT/SE2007/000677

§ 371 Date: Dec. 11, 2009

(51) Int. Cl. B23P 11/00

(52) U.S. Cl. 29/428

(57) ABSTRACT

A method is provided for producing an annular wall structure, the method including the steps of feeding an elongated sheet in its longitudinal direction, plastically deforming a flat surface of the sheet so that a set recess pattern is formed in the elongated sheet during the feeding, and joining edges of a deformed individual sheet and/or edges.

### FIELD OF THE INVENTION AND PRIOR ART

The present invention relates to a method for producing an annular wall structure. The invention is particularly directed at producing wall structures for casings in aircraft engines.

A gas turbine constituting an engine for aviation applications usually comprises the main components: fan, compressor, combustion chamber and turbine. An afterburner chamber may be arranged downstream of the turbine component. The engine furthermore comprises one or more casings, which enclose the aforementioned components. The casing must have the requisite strength whilst at the same time it is desirable for the entire construction, which therefore includes the casing, to have the lowest possible weight in order to give the engine the best possible performance, that is to say the engine achieves a large thrust in relation to its weight.

The casings for gas turbine engines are in the state of the art usually designed as hollow circular cylinders arranged concentrically in relation to the central axis of the engine. Such a casing forms an enclosing shell around the rotating and stationary engine components. Such a cylinder may have an inside diameter in the order of 200 to 4000 mm and a material thickness in the order of 1 to 10 mm. The casing may be formed from one or preferably more such cylinders having a varying diameter, the cylinders being longitudinally joined to one another in order to form a continuous shell in the form of a tube.

Casings in aircraft engines are large parts that contribute substantially to the total engine weight. Therefore, a number of design features have been developed in order to reduce weight while maintaining, or even increasing the stiffness of the casing.

According to a known design, the casing is provided with external elevations or ridges which form a square grid pattern on the outside of the casing. This structure affords a somewhat greater flexural rigidity for the same weight. Further, it is known to provide a surface of the casing with a so-called iso-grid geometry. An iso-grid is a structure which comprises a triangular pattern of ridges arranged in rows of equal sided triangles. Iso-grids have found particular application in thin-wall engine casings, wherein the iso-grids provide additional stiffness.

The ridges may be produced by cutting away material from the basic fabrication of the casing, such as by means of Electro Chemical Machining (ECM), Electro Discharge Machining (EDM) or milling operations. It is also known to produce the ridges by applying additional material to the basic fabrication, so-called Material Deposition (MD).

In both cases, however, the manufacturing process is relatively complicated and this means that such a casing becomes considerably more expensive than a corresponding casing having a plane external surface.

### SUMMARY OF THE INVENTION

One purpose of the invention is to achieve a method for producing the iso-grid structure in a more cost-effective way.

This purpose is achieved by the method steps defined in claim 1. Thus, the purpose is achieved by the steps of feeding an elongated sheet in its longitudinal direction, plastically deforming a flat surface of the sheet so that a set recess pattern is formed in the elongated sheet during the feeding, and joining edges of a deformed individual sheet and/or edges of different deformed sheets to form the annular wall structure.

Contrary to the known material cutting processes, there will be no waist of material by means of the plastic deformation of the sheet. Further, it is a much faster process than the known material deposition processes. Further, the method creates conditions for a high quality of the final component.

According to a preferred embodiment, the method comprises the step of deforming the sheet so that the set pattern is repeated in a longitudinal direction of the sheet. This is preferably accomplished by pressing a member having a projection pattern that is inverse in relation to the set recess pattern onto the material surface during feeding of the material. The member is preferably a rotary member which has the inverse pattern on an external curved surface.

According to a further preferred embodiment, the method comprises the step of extruding a material in such a way that the elongated sheet is produced. This is preferably accomplished by the step of pressing the material past an opening of a die during the extrusion in order to form the sheet with a cross section determined by a geometry of the opening. Thus, the elongated sheet is produced prior to said plastic deformation of the sheet.

Other advantageous features and functions of various embodiments of the invention are set forth in the following description and in the dependent claims.

### BRIEF DESCRIPTION OF THE DRAWINGS

The invention will be explained below, with reference to the embodiments shown on the appended drawings, wherein

FIG. 1 schematically shows a method for producing a strip with an iso-grid structure,

FIG. 2 shows a straight strip provided with an iso-grid structure produced according to the method in FIG. 1,

FIG. 3 shows the strip according to FIG. 2, which has been curved to form a ring and the short-ends of the strip have been joined,

FIG. 4 shows a casing built by a plurality of rings according to FIG. 3, and

FIG. 5 shows a casing built by a plurality of straight strips according to FIG. 2, which have been joined side-by-side.

### DETAILED DESCRIPTION OF PREFERRED EMBODIMENTS OF THE INVENTION

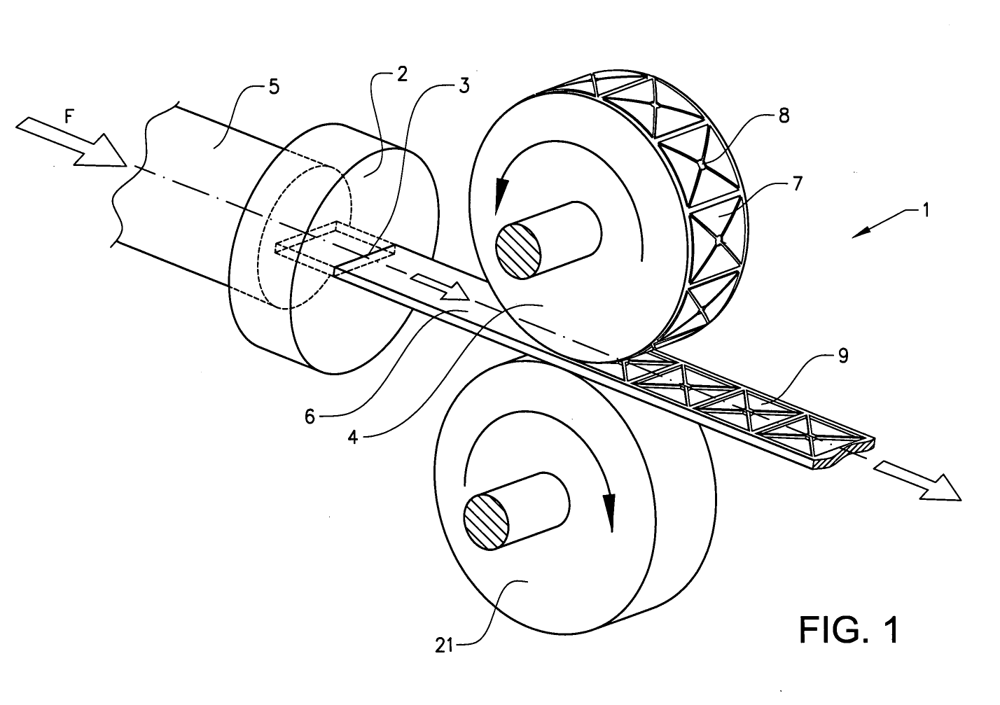

FIG. 1 is a rough schematic representation of a tool 1 adapted for producing an elongated sheet, or strip, with a set recess pattern. The tool 1 comprises a stationary first die 2 with an opening 3 having a set internal geometry, or cross-sectional area. More particularly, the opening 3 has the shape of a straight slot with a substantially rectangular shape.

A blank 5, or work piece, for example a metal such as an aluminium or titanium alloy, which has been heated to a plastically deformable state, is pressed through the opening 3 in the stationary die by means of a ram or similar (not shown). An elongated sheet 6 is thereby formed with a cross section defined by the geometry of the opening 3. Thus, the longitudinal cross-section of the sheet is constant.

A second die in the form of a rotary member 4 is arranged immediately downstream of the first die 2. The rotary die is preferably located so close to the opening 3 that the pressure of the pressing is used in the shaping done by the rotary member 4. The rotary member 4 has a cylindrical part with an external curved surface 7, preferably a cylindrical surface of circular geometry. The surface 7 is provided with a projection pattern 8 adapted for being pressed onto the sheet. More specifically, the projection pattern 8 is inverse in relation to a desired recess pattern on the sheet surface. More specifically, the projection pattern 8 presents an inverse isogrid structure, which is repeated on the external surface 7 in the circumferential direction of the rotary member 4. The projection pattern is substantially continuously repeated in the circumferential direction, i.e with substantially no spacing.

The rotary member 4 is pressed onto the sheet surface during feeding of the sheet, thereby plastically deforming a flat surface of the sheet 6 and forming a substantially continuous isogrid structure 9 in the longitudinal direction of the sheet 6. Thus, the iso-grid structure forms an integrally stiffened structure. In other words, the iso-grid structure is formed in one piece with the sheet during the process. Thus, a plurality of recessed iso-grid pockets is formed in the strip 6 in the longitudinal direction.

An additional rotary member 21 is arranged with parallel rotational axis with regard to the rotary member 4. The additional rotary member 21 forms a counter pressure surface during the deformation and is arranged at a small distance from the rotary member 4 so that the strip 6 may pass between the rotary members 4,21.

Thus, the set pattern 9 is repeated in a longitudinal direction of the sheet. More particularly, a substantially continuous structure of the set pattern is formed in the longitudinal direction of the sheet.

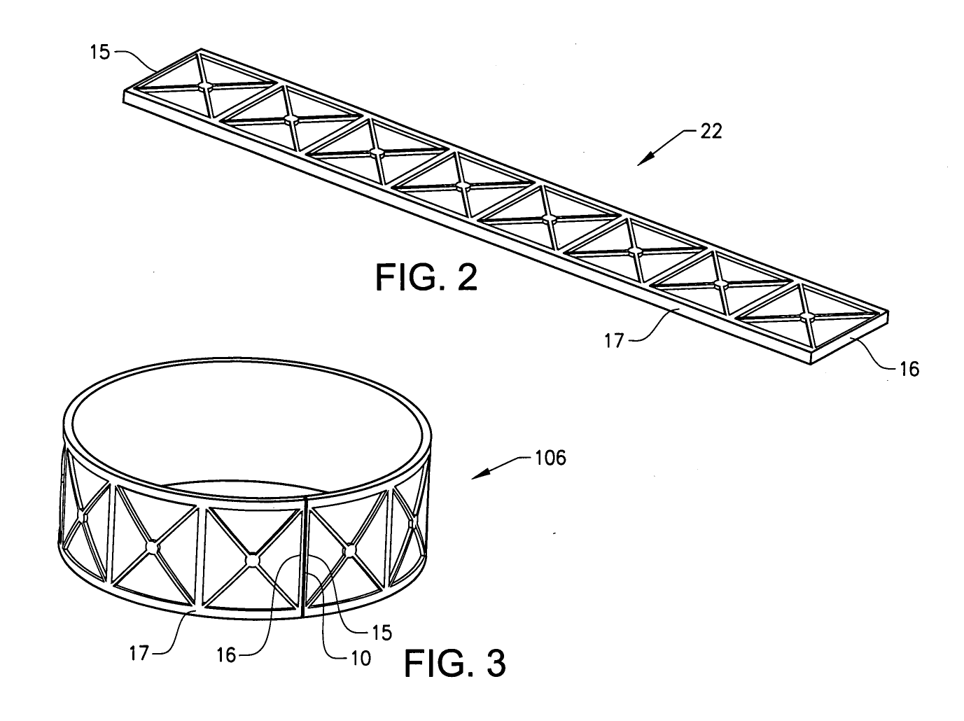

FIG. 2 shows a strip 22 produced by means of the process described above and cut to a desired length.

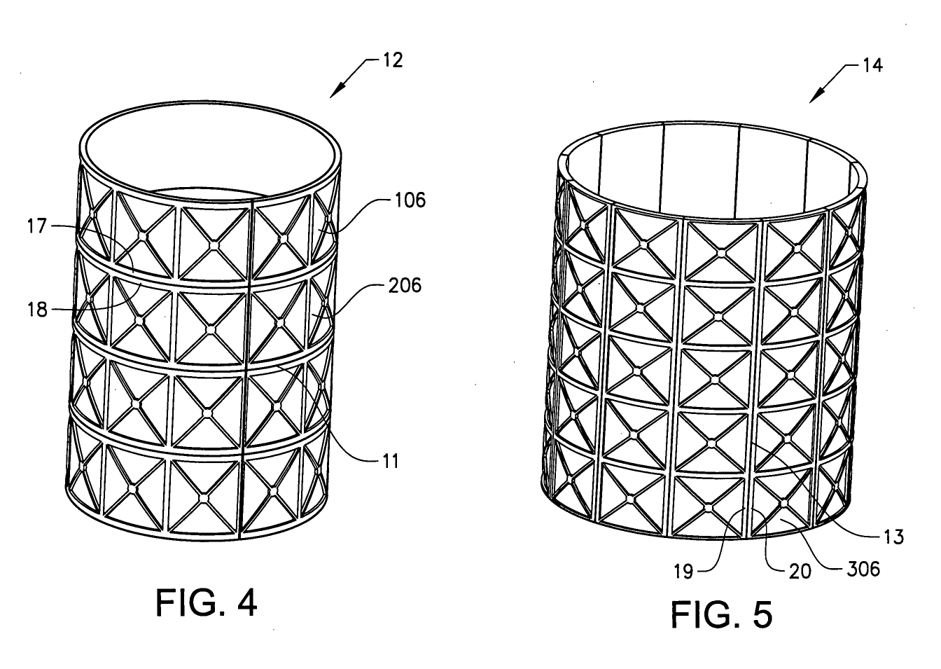

FIGS. 3-4 shows a first alternative of a method for producing an annular structure, preferably a cylindrical aircraft casing by means of a plurality of so-produced strips. Each strip 22 is bent and the short side edges 15,16 of the strip are joined via welding, see FIG. 3. The weld is shown with reference numeral 10. The strip now forms a ring 106. A plurality of rings 106,206 are positioned on top of each other, see FIG. 4, and the long sides 17,18 of the sheets are joined so that an annular wall structure 12 is formed.

FIG. 5 shows a second alternative of a method for producing an annular structure, preferably a cylindrical aircraft casing by means of a plurality of the strips according to FIG. 2. Each strip 22 is bent around a central longitudinal axis of the strip so that the cross section forms a circular sector. A plurality of such bent strips 306 are positioned side by side to form a ring and the long sides 19,20 of the sheets are joined so that the annular wall structure 14 is formed.

The invention is not in any way limited to the above described embodiments, instead a number of alternatives and modifications are possible without departing from the scope of the following claims.

For example also other geometrical shapes than iso-grids may be formed in the strip, such as rectangular structures.

Further, the method is not limited to producing casings for aircraft engines but covers any lightweight lattice type structures, for example for use in stationary gas turbines or space vehicle applications.

Further, for some applications a ring produced by a single strip with said pattern may suffice as an individual casing part.

Further, one or several strips with said pattern may be joined to strips of different design to form a continuous annular structure.

1. A method for producing an annular wall structure, comprising feeding an elongated sheet in its longitudinal direction, plastically deforming a flat surface of the sheet so that a set recess pattern is formed in the elongated sheet during the feeding, and joining edges of a deformed individual sheet and/or edges of different deformed sheets to form the annular wall structure.

2. A method according to claim 1, comprising deforming the sheet so that the set pattern is repeated in a longitudinal direction of the sheet.

3. A method according to claim 2, comprising deforming the sheet so that a substantially continuous structure of the set pattern is formed in the longitudinal direction of the sheet.

4. A method according to claim 1, comprising pressing a member having a projection pattern that is inverse in relation to the set recess pattern onto the material surface during feeding of the material.

5. A method according to claim 4, wherein the member is a rotary member which has the inverse pattern on an external curved surface.

6. A method according to claim 1, comprising extruding a material in such a way that the elongated sheet is produced.

7. A method according to claim 6, comprising pressing the material past an opening of a die during the extrusion in order to form the sheet with a cross section determined by a geometry of the opening.

8. A method according to claim 4, comprising pressing the material past an opening of a die during the extrusion in order to form the sheet with a cross section determined by a geometry of the opening,
wherein the member is arranged adjacent the opening and downstream the opening with regard to the feeding direction.

9. A method according to claim 1, comprising joining the sheet edges via welding.

10. A method according to claim 1, comprising bending the sheet and joining the short sides of the sheet to form a ring.

11. A method according to claim 10, comprising placing a plurality of rings on top of each other and joining the long sides of the sheets so that the annular wall structure is formed.

12. A method according to claim 1, comprising placing a plurality of elongated sheets side by side to form a ring and joining the long sides of the sheets so that the annular wall structure is formed.

13. A method according to claim 1, wherein the set pattern forms an iso-grid structure.

14. A method according to claim 1, wherein the wall structure forms a casing for an aircraft engine.
